(19) United States
(12) Patent Application Publication
(10) Pub. No.: US 2026/0261398 A1
(43) Pub. Date: Sep. 3, 2026

(54) LINK SYNCHRONIZATION FOR CRYSTAL-LESS COMMUNICATION DEVICES

(71) Applicant: Axonne, Inc., Sunnyvale, CA (US)

(72) Inventors: William LO, Cupertino, CA (US); Saman BEHTASH, Palo Alto, CA (US)

(21) Appl. No.: 19/543,854

(22) Filed: Feb. 18, 2026

Related U.S. Application Data
(60) Provisional application No. 63/764,655, filed on Feb. 28, 2025.

(51) Int. Cl. H04L 7/00; H04L 7/027

(52) U.S. Cl. CPC H04L 7/0079; H04L 7/027

(57) ABSTRACT

A communication device configured to communicate with a link partner via a link includes a sampling circuit, a clock generator, a control circuit, and a matched filter. The sampling circuit is configured to sample a signal received via the link and to output samples. The clock generator is configured to generate a clock. The control circuit is configured to adjust a frequency of the clock. The matched filter is configured to receive the clock and the samples, compare the samples to a sequence of bits, and output peaks in response to the samples matching the sequence of bits and in response to the frequency of the clock being offset from a frequency of the signal by less than or equal to a predetermined amount.

### CROSS-REFERENCE TO RELATED APPLICATIONS

This application claims the benefit of U.S. Provisional Application No. 63/764,655, filed on February 28, 2025. The entire disclosure of the application referenced above is incorporated herein by reference.

### FIELD

The present disclosure relates generally to communication devices used in communication systems and more particularly to link synchronization for crystal-less communication devices used in automotive communication systems.

### BACKGROUND

The background description provided herein is for the purpose of generally presenting the context of the disclosure. Work of the presently named inventor, to the extent the work is described in this background section, as well as aspects of the description that may not otherwise qualify as prior art at the time of filing, are neither expressly nor impliedly admitted as prior art against the present disclosure.

IEEE 802.3chand IEEE 802.3cyare automotive Ethernet standards. According to these standards, two devices in a vehicle communicate point-to-point via a single pair of twisted wires. In IEEE 802.3ch, master and slave devices define physical layer (PHY) timing for synchronized communication. The master device provides the timing and the slave device locks to that timing, which allows for reliable high-speed bidirectional communication over a single pair of twisted wires in automotive environments. In IEEE 802.3cy, master and slave define clock and link synchronization roles as follows. The master PHY uses an internal clock for timing. The slave PHY recovers timing from signals received from the master to establish a reliable link. The master actively polls and the slave responds, often using specific synchronization frames called SEND_S for clock alignment, which allows for deterministic real-time communication.

Two devices (e.g., master and slave) that communicate with each other via a communication link are generally called link partners. The link partners typically perform synchronization and training procedures upon power-up and power-on reset (POR). Some devices also use echo canceling system to reduce interference that can be caused by signals reflected from within the devices and/or from the link partner.

There are many ways to train two devices on a link. One way that completely side-steps the need for link synchronization is where the master simply transmits a continuous signal and the slave recovers that continuous signal. However, continuous signaling is not desirable because the master should not transmit non-stop when the slave is not there to respond. Also a reliable way is needed to detect that there are two devices ready to establish a link.

### SUMMARY

A communication device configured to communicate with a link partner via a link comprises a sampling circuit, a clock generator, a control circuit, and a matched filter. The sampling circuit is configured to sample a signal received via the link and to output samples. The clock generator is configured to generate a clock. The control circuit is configured to adjust a frequency of the clock. The matched filter is configured to receive the clock and the samples, compare the samples to a sequence of bits, and output peaks in response to the samples matching the sequence of bits and in response to the frequency of the clock being offset from a frequency of the signal by less than or equal to a predetermined amount.

In other features, the clock generator is configured to generate the clock without using a reference clock.

In other features, the clock generator is configured to generate the clock without using a crystal oscillator.

In other features, the matched filter is configured to output the peaks in presence of noise in the signal.

In other features, the peaks have values greater than or equal to a predetermined threshold.

In other features, the control circuit is configured to select an initial frequency for adjusting the clock, change the selected frequency until the matched filter outputs a peak, and fine-tune a last selected frequency at which the matched filter outputs the peak to set the frequency of the clock.

In other features, the signal comprises bursts of pulses with each burst being of a fixed duration and with successive bursts being separated by a fixed spacing.

In other features, the communication device further comprises a signal detector configured to detect the bursts. The control circuit is configured to adjust the frequency of the clock based on duration of the detected bursts and spacing between the detected bursts.

In other features, each burst comprises a pseudo-random bit sequence (PRBS) that keeps advancing by one bit position every bit time between the successive bursts.

In other features, the control circuit is configured to count number of cycles of the clock between two successive bursts of pulses, and adjust the frequency of the clock based on the count.

In other features, the control circuit is configured to count number of cycles of the clock between pairs of successive bursts of pulses, and adjust the frequency of the clock based on an average of the counts.

In other features, the control circuit is configured to count number of cycles of the clock between first peaks output by the matched filter for two successive bursts of pulses, and adjust the frequency of the clock based on the count.

In other features, the control circuit is configured to count number of cycles of the clock between first peaks output by the matched filter for first and third bursts of pulses, and adjust the frequency of the clock based on the count.

In other features, the control circuit is configured to count number of cycles of the clock for a duration of (i) a first burst of pulses, (ii) between two successive bursts of pulses, and (iii) a second burst of pulses; adjust the frequency of the clock based on the count between two successive bursts of pulses in response to the three counts being within an expected variation of the clock generator; count, in response to the match filer detecting peaks in response to the adjustment, number of cycles of the clock between first peaks output by the matched filter for two successive bursts of pulses; and set the frequency of the clock based on the count of cycles of the clock between the first peaks.

In other features, the control circuit is configured to count number of cycles of the clock for a duration of (i) a first burst of pulses, (ii) between two successive bursts of pulses, and (iii) a second burst of pulses; adjust the frequency of the clock based on the count between two successive bursts of pulses in response to the three counts being within an expected variation of the clock generator; change the adjusted frequency non-linearly until the matched filter outputs a peak in response to the match filer detecting peaks in response to the adjustment; count, in response to the match filer detecting peaks, number of cycles of the clock between first peaks output by the matched filter for two successive bursts of pulses; and set the frequency of the clock based on the count of cycles of the clock between the first peaks.

In other features, the communication device further comprises a transmitter configured to transmit, using the clock with the adjusted frequency, a second signal to the link partner via the link in response to the received signal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a schematic showing a training sequence between two devices according IEEE802.3ch standard.

FIG. 2 is a schematic showing a training sequence between two devices according IEEE802.3cy standard.

FIG. 3 is an example of a communication system comprising a first (master) device and a second (slave) device configured to communicate with each other via a communication link.

FIG. 4A is an example of a transceiver of the slave device comprising a transmitter and a crystal-less receiver that can be implemented in the second device of FIG. 3 according to the present disclosure.

FIG. 4B is an example of a transceiver of the master device comprising a transmitter and a receiver that uses a crystal clock reference that can be implemented in the first device of FIG. 3 according to the present disclosure.

FIGS. 5-12 show peaks detected by matched filters of the receivers of FIGS. 4A and 4B (FIGS. 5, 7, 9, and 11 show peaks detected by the matched filter of FIG. 4B and FIGS. 6, 8, 10, and 12 show peaks detected by the matched filter of FIG. 4A).

FIGS. 13 and 14 respectively show frequency difference on x-axis and difference in strength between peaks and non-peaks detected by matched filters of receivers of FIGS. 4B and 4A on y-axis.

FIGS. 15 and 16 show duration and spacing between signals received by the receiver of FIG. 4A.

FIGS. 17A and 17B is a method performed by the slave device for quickly converging the frequency of the clock generated by the clock generator to a target frequency with limited number of adjustments to the clock generator according to the present disclosure.

In the drawings, reference numbers may be reused to identify similar and/or identical elements.

### DESCRIPTION

When echo cancelling is used, a typical startup sequence between master and slave devices is as follows. One side (master device) starts to transmit and the other side (slave device) remains silent. During this time, the master device trains the echo canceller of the master device while the slave device performs timing recovery and trains the receiver of the slave device. Once both sides (master and slave devices) complete this step, the slave device also transmits. During this phase of training, both devices (master and slave devices) train their echo cancellers and receivers and perform timing recovery.

Before the training starts, some mechanism is used to indicate when both devices (master and slave devices) are ready to start the training sequence. Traditionally, auto-negotiation defined in IEEE 802.3 is used as the mechanism. Auto-negotiation is a process in which two devices automatically communicate to determine and agree upon the fastest and most efficient communication settings (e.g., speed and duplex mode) using Fast Link Pulses (FLPs) to exchange capabilities without manual configuration, which ensures compatibility and optimal performance. An alternative mechanism to achieve the same result is used in systems such as 1000BASE-T1, 2.5GBASE-T1, 5GBASE-T1, 10GBASE-T1, 25GBASE-T1. The alternative mechanism is the link synchronization as defined in IEEE 802.3 Clause 97, Clause 149 (802.3ch) and Clause 165 (802.3cy).

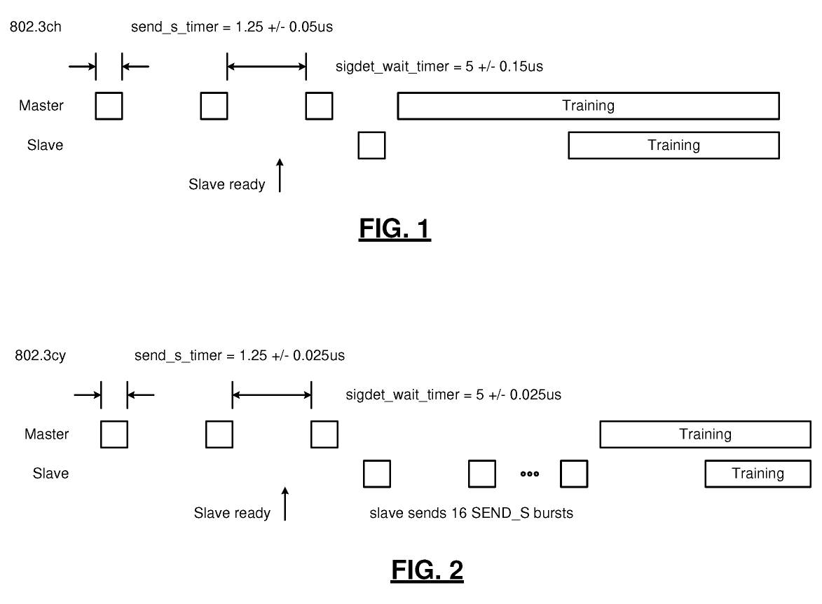

FIGS. 1 and 2 show examples of the alternative mechanism in IEEE 802.3ch and IEEE 802.3cy, respectively, which are standards for wired automotive Ethernet networks. In the alternative mechanism, in IEEE 802.3ch, the master device starts to send bursts of a signal called SEND_S for about 1.25us (using a send_s_timer). The master device then goes quiet or silent (stops transmitting) for about 5us (using a sigdet_wait_timer, where sigdet means signal detect) until the master device sees a SEND_S signal from the slave device. In IEEE 802.3cy, the slave device sends 16 SEND_S signals instead of only one SEND_S signal (as in IEEE 802.3ch) to ensure (avoid any doubt) that the master device has received a SEND_S signal. The SEND_S signal is a pseudo-random binary sequence (PRBS) signal that repeats every 255 symbols. A PRBS signal is a stream of 1s and 0s that appears random but is generated using a deterministic algorithm. Therefore, a PRBS signal can be periodic and predictable if the starting point is known.

Usually, at the receiver, a matched filter is used to detect the SEND_S signal. For example, a simple comparator samples the incoming data and outputs digitalized +1 and -1. For example, 255 consecutive samples of +1 and -1 are matched against a filter with a length 255. If all 255 samples line up, the matched filter outputs a strong peak. The sampling is open loop; that is, the sampling frequency at the receiver is not aligned to the transmit frequency.

In typical systems, there is a requirement that the local clock frequencies of the devices be within +/-50 PPM. Such a system is very robust to noise. The 1.25us duration of the SEND_S signal as defined in IEEE802.3ch and IEEE802.3cy allows about 3.5 PRBS cycles, which result in 3 peaks in the output of the matched filter. When not matched or when nothing is being transmitted, the matched filter output does not peak.

It is advantageous for two devices (link partners) to complete link synchronization and training and enter normal operation as soon as possible once both devices are ready to start synchronization and training. This is particularly important in automotive applications. For example, in an application where a camera is activated when a vehicle backs up, the camera needs to be ready in under 2 seconds from ignition. Typically, every device in a system is given a time budget (a predetermined time period) within which the device must power up and become ready for normal operation.

In systems where local clocks are close in frequency, say within +/-50 PPM, the process of synchronization and training is relatively quick. Typically, the slave device needs to receive one SEND_S signal from the master device and then respond with (i.e., transmit) a SEND_S signal. To meet the close frequency requirement, both devices (master and slave devices) need an external clock reference. The external clock reference is typically a crystal oscillator.

However, it is advantageous if the external clock reference is used in the master device but is not required in a system at the slave device. In a typical automotive deployment, the slave device is usually in the form of a camera (or another sensor). The slave device such as a camera is cost-sensitive and is also housed in a relatively small enclosure (as are many other sensors). Eliminating external clock reference component (e.g., crystal oscillator) in the slave device saves both cost and space.

Usually, the clock source such as a crystal oscillator can be replaced with some form of signal where a clock is embedded with the data. Examples of such signals include signals encoded using Manchester encoding, differential Manchester encoding (DME), or 8bit-10bit encoding. However, the problem with a device not using an external clock reference such as a crystal oscillator is that it is not possible to tune a PLL or an internal oscillator on the device to anywhere near +/- 50 PPM.

In principle, the master device can transmit a continuous data stream with an embedded clock that can be used as clock reference. For example, Manchester signaling or differential Manchester signaling can be used to embed clock in the data. However, the problem is that during link synchronization process, the SEND_S signal is not a continuous signal, and it can take a long time to frequency lock to an intermittent signal, especially if the starting local clock frequency is far away from the locked frequency.

Typically a free running internal oscillator can be designed to be +/-15% (150000 PPM) of the desired frequency. However, the matched filter cannot adequately detect anything even +/-2% off. Hence the slave device needs to lock to a frequency that is close enough to a target frequency so that the slave device can send a SEND_S pulse that is detectable at the matched filter in the master device.

Accordingly, there is a need for a crystal-less receiver for the slave device that can quickly lock to a frequency that is close enough so that the matched filters can reliably detect a burst of signal on both master and slave devices in a link. Notably, the +/-50 PPM difference between the local clock frequencies is not needed in this stage. Rather, what is needed is some difference that is small enough for the matched filters to operate properly. The present disclosure provides a link synchronization mechanism for crystal-less communication devices where the master device uses a crystal clock reference (or any other source that generates a stable clock) and where a crystal-less receiver of the slave device uses the signal received from the master device to estimate timing and can quickly lock to a frequency that is close enough so that the matched filter of the slave device can reliably detect a burst of signal.

Throughout the present disclosure, a crystal-less slave device operating with asymmetrical speeds is used as an example where the crystal-less slave device receives a slow differential Manchester encoded signal as input and the slave device transmits a high-speed signal. The crystal-less slave device recovers the received signal, extracts the clock from the received signal, and uses that clock reference to transmit the high-speed signal. The crystal-less operation can also be used in slave devices operating with symmetrical speeds or if a different form of encoded signal is used and is not limited to DME, which is used only as an illustrative example.

Throughout the present disclosure, examples show a 117.1875 MHz SEND_S signal being received and a 703.125 MHz SEND_S signal being transmitted. The lower speed signal is DME encoded, while the higher speed signal is PAM2 encoded. The SEND_S signal uses a PRBS sequence of 63 for the slower signal and uses a PRBS sequence of 255 for the faster signal. The SEND_S signal duration and spacing is as shown for IEEE802.3cy in FIG. 2.

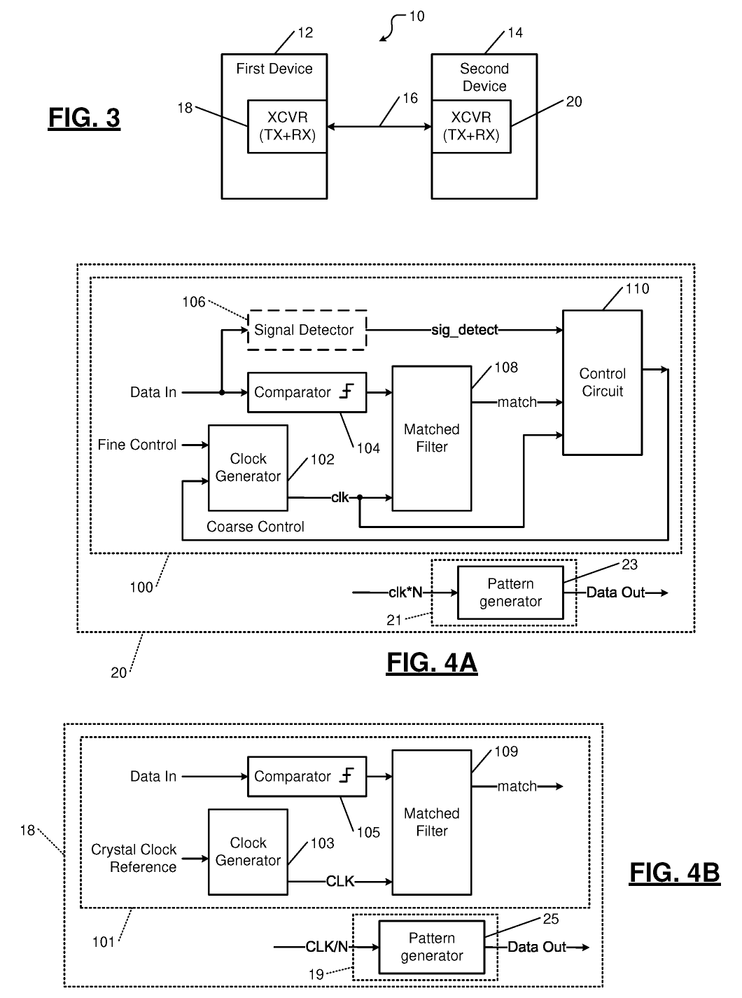

FIG. 3 shows an example of a communication system 10 comprising a first device 12 and a second device 14 configured to communicate with each other via a communication link 16. For example, the first device 12 can be a master device, and the second device 14 can be a slave device. For example, the communication link (or simply the link) 16 can be a wireline link (a single twisted pair of wires) in a wired automotive Ethernet network.

The first device 12 comprises a transceiver (XCVR) 18, and the second device 14 comprises a transceiver (XCVR) 20. The transceivers 18, 20 are configured to communicate with each other via the link 16. Each of the transceivers 18, 20 comprises a transmitter (TX) and a receiver (RX). The transceiver 18 of the first (master) device 12 uses a crystal clock reference (e.g., a crystal oscillator). The transceiver 20 of the second (slave) device 14 is crystal-less and does not use a crystal clock reference. Transmissions from the transmitter of the first device 12 are received by the receiver of the second device 14 via the link 16, and transmissions from the second device 14 are received by the receiver of the first device 12 via the link 16. The first and second devices 12, 14 can perform link synchronization as described below.

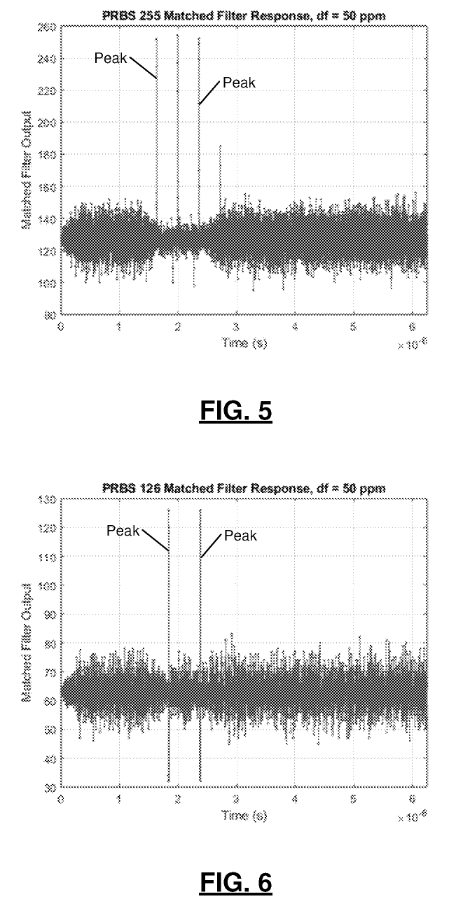

FIGS. 4A and 4B show examples of the transceivers 20, 18 of the second and first devices 14, 12, respectively. In FIG. 4A, the transceiver 20 of the second (slave) device 14 comprises a crystal-less receiver 100 according to the present disclosure and comprises a transmitter 21. In FIG. 4B, the transceiver 18 of the first (master) device 12 comprises a receiver 101 that uses a crystal clock reference and comprises a transmitter 19. The crystal-less receiver 100 can perform link synchronization quickly by locking to a frequency that is close enough so that the matched filter can reliably detect a burst of signal on both master and slave devices 12, 14 communicating over the link 16. For example, if the slave’s clock frequency is off from the master’s clock frequency by a relatively large amount, the master’s transmitted data will arrive at frequency A and the slave will sample the data at frequency B. If the slave transmits data at frequency B, the master will sample the data at frequency A. Neither the master nor the slave can detect the data using the respective matched filters clocked by the respective clocks. Instead, once the slave’s clock frequency is adjusted close enough to the master’s clock frequency using the systems and methods of the present disclosure, the matched filters of both master and slave devices 12, 14 can detect the peaks as described below.

For example, in FIG. 4A, the crystal-less receiver 100 comprises a clock generator 102, a comparator 104, a signal detector 106 (optional), a matched filter 108, and a control circuit 110. While the crystal-less receiver 100 is shown as comprising specific components, one or more components can be substituted with similar components. The transmitter 21 comprises a pattern generator 23 for transmitting SEND_S signals. While not shown, the control circuit 110 can also control the transmitter 21. In FIG. 4B, the receiver 101 comprises a clock generator 103, a comparator 105, and a matched filter 109. The transmitter 19 comprises a pattern generator 25 for transmitting SEND_S signals. While not shown, a control circuit can also control the components of the receiver 101 and the transmitter 19. The operations of the comparators 104, 105 are similar. The matched filters 108, 109 can be similar or different. In the example described herein, since data transmission in one direction is a lot faster than the data transmission in the other direction, the matched filters 108, 109 of the master and slave devices 12, 14 are of different lengths (e.g., one is of length 255 and the other is of length 126). The main difference between the receivers 100 and 101 of the slave and master devices 14, 12 is that the clock generator 102 of the receiver 100 of the slave device 14 does not use a crystal clock reference to generate a local clock clk of the slave device 14 whereas the clock generator 103 of the receiver 101 of the master device 12 uses a crystal clock reference to generate a local clock CLK of the master device 12.

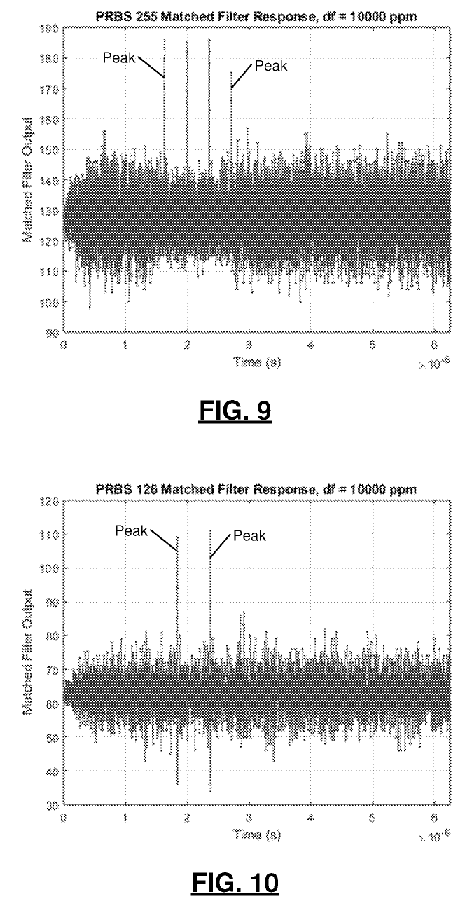

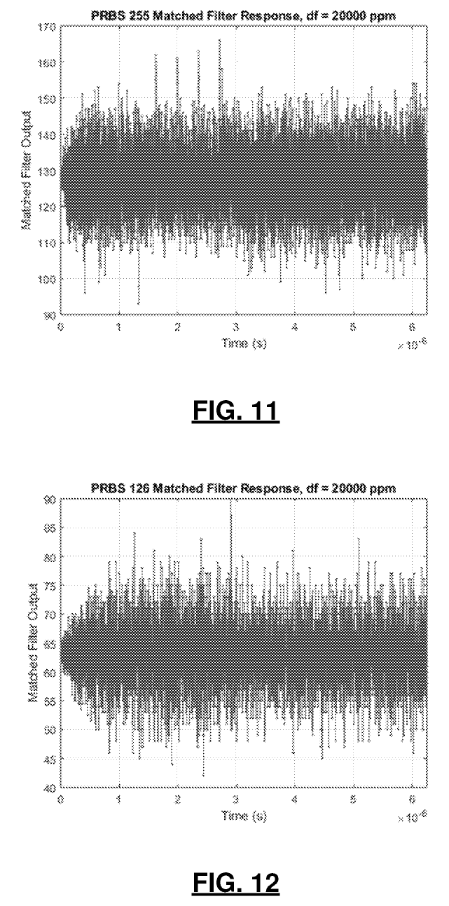

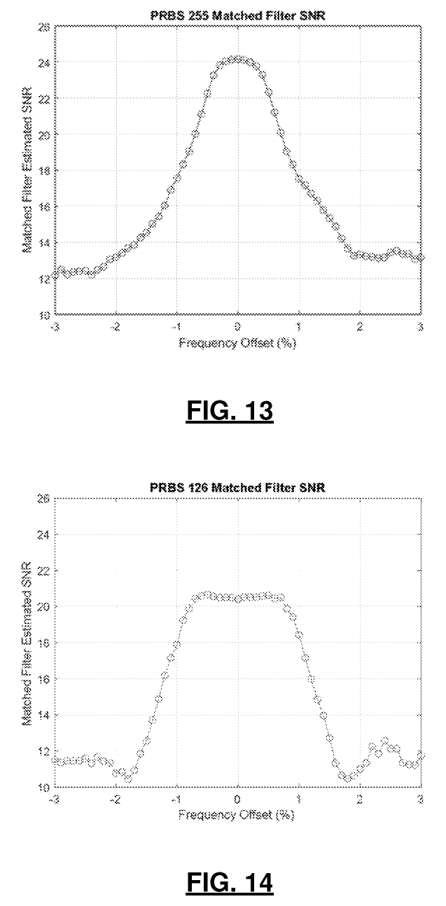

For example, at the slave device 14, clk = 117.1875 MHz, and the transmitter 21 is driven by N*clk, where N = 6 so that N*clk = 703.125 MHz. At the master device 12, CLK = 703.125 MHz, and the transmitter 19 is driven by CLK/N, where N = 6 so that CLK/N = 117.1875 MHz. The clock CLK/6 at the master device 12 is derived from the clock CLK generated by the clock generator 103 using the crystal clock reference. The transmitter 19 transmits a signal SEND_S at 117.1875 M DME symbols per second. The receiver 100 receives this DME symbol stream as Data In and attempts to match the frequency of the clock clk to within 1% or better of the clock CLK/6 using the following control loop: Data In, the matched filter 108, the control circuit 110, and the clock generator 102 as shown in FIG. 4A and explained below in detail. The control loop is needed because the receiver 100 is crystal-less. The control loop will not be needed if the difference between the local clock frequencies clk and CLK/6 is +/-50 PPM. Until the slave clock clk gets within 1% of the master clock CLK/6, SEND_S transmitted by the slave device 14 cannot be detected by the master device 12 since the slave clock does not match the master clock. If the mismatch between the slave and master clocks is large, the peaks output by the matched filters are not clearly discernible as shown in FIGS. 11 and 12. If the mismatch is within 1%, the peaks can be similar to those shown in FIGS. 9 and 10.

The crystal-less receiver 100 of the slave device 14 is now described in further detail. The clock generator 102 generates a clock (clk) having a clock frequency. For example, the clock generator 102 can be voltage controlled, current controlled, controlled with digital codes, LC-PLL, ring PLL. The clock generator 102 does not use a crystal oscillator to generate the clock (clk). The clock frequency is controlled using two inputs: a coarse control and a fine control. The following description explains how coarse control is achieved to get the clock frequency close enough to a target frequency based on receiving intermittent signals such as the SEND_S signal (shown as Data In) described above. The coarse frequency adjustment is close enough for the device to reliably detect the SEND_S signal received from the link partner as well as transmit a SEND_S signal that is close enough in frequency that the link partner can reliably detect.

In the following description, the term SEND_S is used as a shorthand for a SEND_S signal burst transmitted by both the master and slave devices 12, 14. At the slave device 14, the fine control is used to lock into the target frequency once there is a continuous signal received during the initial training and subsequent normal operation. The target frequency is a frequency of the clock signal clk that is sufficiently close to (within +/-0.5% of) the frequency of the SEND_S signal received from the link partner (the master device 12) and is a frequency of the clock signal clk at which the matched filter 108 can detect a peak in the SEND_S signal received from the link partner (the master device 12).

The data received over the link 16 is input to the receiver 100 as Data In after some filtering and conditioning (e.g., performed in an analog frond-end or AFE not shown). The data is sampled by a simple 2 level comparator 104 (also called a sampling circuit) and optionally by a signal detector 106. The signal detector 106 senses when there is energy present on the input (i.e., when the SEND_S pulse is present on the link 16 vs the link 16 being quiet, which, for example, is the case between two successive pulses). In some examples, the comparator 104 and the signal detector 106 can also be implemented as a combined multi-level comparator or ADC.

Using the clock signal clk, the matched filter 108 shifts in 255 samples output by the comparator 104 to compare against the sequence of PRBS of length 255, or shifts in 126 samples output by the comparator 104 to compare against the sequence of PRBS of length 63 (2x63 samples if a DME signal). Ideally, a peak value output by the matched filter 108 is 255 or 126, respectively, when the samples match all the bits in the sequence of PRBS. If the data on the link 16 is random, the peak value output by the matched filter 108 will average around 127.5 and 63, respectively. Accordingly, a high value (greater than or equal to a predetermined threshold defined below) indicates a good match, otherwise indicates no match. For example, the peak value will not be a high value (will be less than the predetermined threshold) if the data on the link 16 is random or if nothing is being transmitted on the link 16.

As used herein, the peaks in the output of the matched filter have a value greater than or equal to a predetermined threshold. For example, the predetermined threshold is greater than a value of the output of the matched filter if the samples do not match all the bits in the sequence of PRBS, if the data on the link 16 is random, if only noise and no other signal is present on the link 16, or if nothing is present on the link 16. The peaks indicate reliable detection of a burst of a signal on the link 16 in both master and slave devices 12, 14 when the peaks have a value greater than or equal to the predetermined threshold.

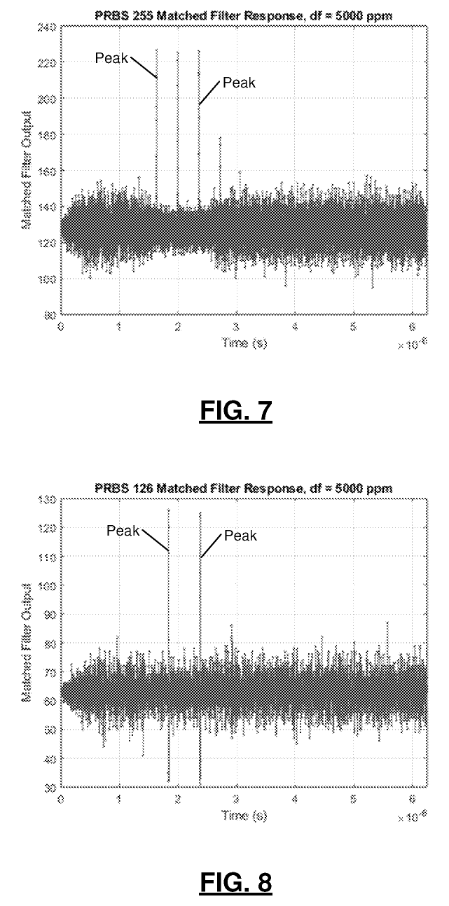

FIGS. 5-12 show a high peak when the matched filters indicate (detect or output) a good match. In these figures, note that random noise is added to the SEND_S signals, but the peak detection is clearly visible since the matched filters are robust in the presence of noise. Note also that PRBS 126 is really a PRBS of length 63 with DME applied since the DME outputs 2 encoded bits (being differential) per bit of data, and 63 gets doubled to 126.

FIGS. 5 and 6 show the responses of the matched filters including the peaks detected by the matched filters for PRBS 255 and PRBS 126, respectively, with frequencies of the clock clk and the received signal off by +/-50 PPM (0.005%). FIGS. 7 and 8 show the responses of the matched filters including the peaks detected by the matched filters for PRBS 255 and PRBS 126, respectively, with the frequencies off by +/- 5000 PPM (0.5%). FIGS. 9 and 10 show the responses of the matched filters including the peaks detected by the matched filters for PRBS 255 and PRBS 126, respectively, with the frequencies off by +/- 10000 PPM (1%). FIGS. 11 and 12 show the responses of the matched filters for PRBS 255 and PRBS 126, respectively, with the frequencies off by +/- 20000 PPM (2%), where the matched filters does not perform (detect peaks) optimally due to excessive frequency offset.

FIGS. 13 and 14 show the frequency difference on x-axis and the difference in strength between peaks and non-peaks detected by the matched filters on y-axis. As the frequency difference gets closer to 0%, the difference in strength between peaks and non-peaks detected by the matched filter 108 becomes larger (i.e., the peaks become clearly distinguishable). For example, in FIGS. 5 and 6, where the frequency difference is 0.005%, the difference in strength between peaks and non-peaks detected by the matched filter 108 is large. In contrast, in FIGS. 11 and 12, where the frequency difference is 2 %, the peaks detected by the matched filters are not very distinguishable.

The control circuit 110 quickly adjusts the coarse control to tune the frequency of the clock clk generated by the clock generator 102 as follows. The control circuit 110 can use one of two methods to quickly adjust the coarse control: a blind search or a directed search. The two methods can be used independently or in combination as described below.

In the blind search method, the control circuit 110 blindly sets a selected frequency for the clock generator 102 and waits for an amount of time to see whether the matched filter 108 outputs a sharp peak at the selected clock frequency. If not, the control circuit 110 moves to a next frequency and so on until a match (sharp peak) is detected by the matched filter 108. When the match (sharp peak) is detected by the matched filter 108, the frequency of the clock clk is close enough to the frequency of the received signal. For example, the frequency of the clock clk is within +/- 0.5% of the frequency of the received signal and the offset between the two frequencies is definitely less than 2%.

It takes time for the clock generator 102 to settle to the adjusted frequency after a frequency setting of the clock generator 102 is changed by the coarse adjustment selected by the control circuit 110. Hence it is advantageous to limit the number of adjustments needed to be made by the control circuit 110. In this example, it is preferrable for the clock frequency to be within 0.5% of the target frequency instead of linearly adjusting the setting (e.g., -15%, - 14%, - 13%, … etc.). Accordingly, the control circuit 110 can select the coarse adjustments nonlinearly (in uneven steps) such as -15%, -13%, …; or -15%, -14%, -12%, …; etc. The adjustment can be linear, non-linear, or in any other order. For example, the adjustment can be one step at a time from a high value to a low value or vice versa. The adjustment can also start with a value at a center of a range, and the value can then be increased or decreased to either end of the range. Alternatively, the adjustment can also include randomly selecting values. Once the matched filter 108 detects a peak for a selected frequency, the control circuit 110 can adjust (fine-tune) the selected frequency that provides the peak by +/- 0.5% to find the best peak.

Compared to the blind search method, the directed search method described below is a faster way to search and select the frequency of the clock clk at which the matched filter 108 can detect a peak. The directed search method takes advantage of the optional signal detector 106 and changes how the SEND_S signals are transmitted. Specifically, instead of allowing some variation of 1.25us +/- 0.025us duration and 5 +/- 0.025us spacing of pulses of the SEND_S signals as in the 802.3cy case, the duration and spacing of the SEND_S signals is fixed. For example, the duration can be fixed to be exactly 148 bits, and the spacing can be fixed to be exactly 588 bits. This corresponds closely to 1.25us duration and 5us spacing of pulses of the SEND_S signals, respectively.

The signal detector 106 can detect the bursts of pulses in the SEND_S signals. Accordingly, based on the output of the signal detector 106 indicating when the burst are detected, the control circuit 110 can determine duration of a burst and spacing between bursts in the SEND_S signals. Specifically, since the signal detector 106 can detect when a burst begins and ends, the control circuit 110 can count the number of clock cycles during a burst (which provides duration of the burst), between two successive bursts (i.e., during the spacing between two successive bursts, which provides spacing between two successive bursts), between alternate bursts, and so on.

With no variability in duration and spacing of the SEND_S signal, the control circuit 110 can count the number of clock cycles that elapse between pulses of the SEND_S signal to estimate how far off the current frequency of the clock clk is from the target frequency. The higher the difference between the count and an expected count (known due to the fixed duration and spacing), the more the clock frequency should be slowed down by the coarse adjustment and vice versa. If the signal detector 106 has a resolution of +/-7 bits, one such measurement alone makes the estimate to be within +/- 1% of the target frequency, which is closer to the desired offset of +/- 0.5% than the undesired offset of 2%.

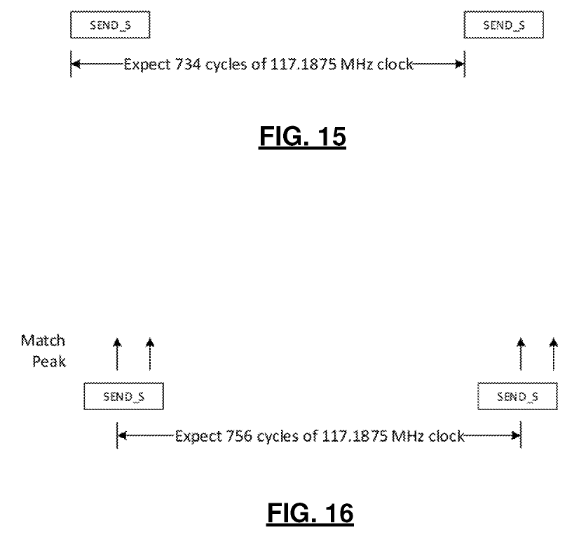

For example, in FIG. 15, with 734 cycles of 117.1875 MHz clock between two SEND_S signals and with the signal detector 106 having a resolution of +/-7 bits, 7/734 = 1%. To account for possible noise, the control circuit 110 can average a few measurements (e.g., three measurements, which take relatively small amount of time) to quickly arrive at this estimate. The control circuit 110 can then apply the blind search method to a much smaller search space (a narrow range of frequencies to select) to quickly arrive at the correct frequency.

Once peaks are detected by the matched filter 108, the accuracy of the frequency of the clock signal clk can be adjusted to within (less than) 0.2% in this example by making one additional requirement on the SEND_S signal – that of counting number of clock cycles that elapse between the first strong peaks of two SEND_S signals or between the peaks on the first and third SEND_S signals as follows.

As described above, the SEND_S signal can be output for 148 bits (fixed duration) and goes quiet for 588 bit-times (fixed spacing) before being sent again. The PRBS advances by one bit position when the SEND_S signal is output. If the PRBS continues to advance one bit position every bit-time during the quiet period (between successive bursts), the control circuit 110 can take advantage of the PRBS sequence to determine time.

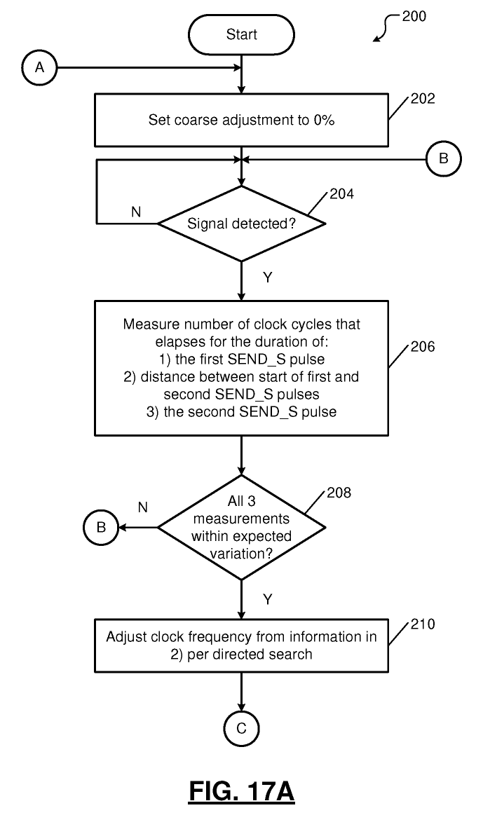

For example, in FIG. 16, by counting the number of clock cycles that elapse between the first strong peaks of two SEND_S signals (also called a distance between matched peaks), the control circuit 110 can estimate the frequency difference to 1 bit time resolution. With 756 cycles of 117.1875 MHz clock between first strong peaks of two SEND_S signals, 1/756 is less than 0.2%. If the control circuit 110 counts the number of clock cycles that elapse between the matched peaks on the first and third SEND_S signals (e.g., first strong peaks of the first and third SEND_S signals), the accuracy can be within less than 0.1%.

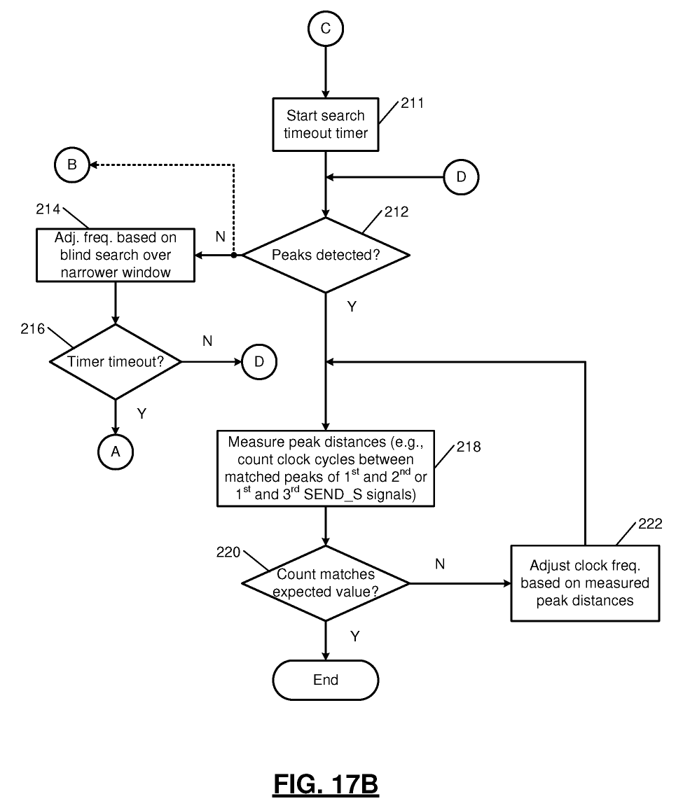

FIGS. 17A and 17B show a method 200 performed by the control circuit 110 of the slave device 14 for quickly converging the frequency of the clock clk, which is generated by the clock generator 102 without using a crystal oscillator, to a target frequency with limited number of adjustments to the clock generator 102. The method 200 is performed by the slave device 14 when any of the master and slave devices 12, 14 is powered up or performs a power-on reset operation. For example, the control circuit 110 can comprise a memory to store instructions for performing the method 200 and a processor to execute the instructions to perform the method 200.

The method 200 assumes that the variation in frequency of the clock clk generated by the clock generator 102 at power-up or power-on reset is +/-15% off target when the initial coarse adjustment is set to 0%. Using the method 200, the control circuit 110 of the slave device 14 can quickly lock the frequency of the clock clk to a target frequency that is close enough so that the matched filter 108 can reliably detect peaks, and the master and slave devices can quickly perform link synchronization.

At 202, the control circuit 110 sets the coarse adjustment to 0%. At 204, the control circuit 110 waits until a signal is detected on the link 16. When a signal is detected on the link 16, at 206, the control circuit 110 counts the number of clock cycles that elapse for the duration of 1) the first SEND_S pulse received over the link, 2) the distance between the start of the first and second SEND_S pulses received over the link 16, and 3) the second SEND_S pulse received over the link 16.

At 208, the control circuit 110 determines if all three measurements are within the expected variation based on the design of the clock generator 102. For example, the clock generator 102 can be designed for detecting specific SEND-S signals described above. All three measurements will be within the expected variation if the received signal is a SEND_S signal but since the clock generator 102 is not yet tuned. All three measurements will not be within the expected variation if the received signal is not a SEND_S signal. If all three measurements are not within the expected variation, the method 200 returns to 204. If all three measurements are within the expected variation, at 210, the control circuit 110 adjusts the clock frequency based on the information in 2) using the directed search method described above.

At 211, the control circuit 110 starts a timer. At 212, the control circuit 110 determines if, after the adjustment, the matched filter 108 detects peaks using the adjusted clock. If the matched filter 108 does not detect peaks, the method 200 can return to 204 or proceed to 214. If the matched filter 108 detects peaks, the method 200 proceeds to 218.

At 214, the control circuit 110 can perform the blind search method described above to adjust the clock frequency over a narrower frequency window (narrowed by the directed search). At 216, the control circuit 110 determines if the timer has timed out (expired). The method 200 returns to 202 if the timer has timed out. The method returns to 212 if the timer has not timed out.

At 218, the control circuit 110 measures peak distances (counts number of clock cycles elapsed between the peaks) as described above. At 220, the control circuit 110 determines if the count matches an expected value (expected based on the fixed duration spacing as described above). If the count does not match the expected value, at 222, the control circuit 110 adjusts the clock frequency based on the count, and the method 200 returns to 218. The method 200 ends if the count matches the expected value.

Accordingly, the control circuit 110 of the slave device 14 can perform the method 200 to quickly converge the frequency of the clock clk, which is generated by the clock generator 102 without using a crystal oscillator, to a target frequency with limited number of adjustments to the clock generator 102 by utilizing the following features. The duration and spacing of the SEND_S signal are exact and are not variable because the master device 12 uses a crystal oscillator for generating the local clock as described above. The PRBS of the SEND_S signal keeps advancing even during the quiet period. The method 200 uses the blind search method to hone-in on the target frequency using the matched filter 108 for peak detection. The blind search can be performed nonlinearly to reduce the number of trials (the number of adjustments to the clock generator 102) as described above. The method 200 uses the peak spacing to zero-in on the target frequency. Using the SEND_S signal spacing for signal detection reduces the search space (frequency search window). The method 200 also checks the duration and spacing of the SEND_S signal to see if they are within the expected range of variation of the clock generator 102. This operation is performed to prevent any noise on the link 16 from triggering the calculations (i.e., to make the method 200 robust and immune to noise).

In use, the slave device 14 performs the method 200 and adjusts its clock as described above; then using the adjusted clock, the slave device 14 transmits a response (SEND_S signal) to the master device 12, which then similarly completes the link synchronization and training based on the received response. Thus, using the method 200, the devices 12, 14 can finish the link synchronization and training and can enter (i.e., be ready for) normal operation within a designated predetermined time period from power-up or power-on reset.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the embodiments described are not mutually exclusive, and permutations of one or more embodiments with one another remain within the scope of this disclosure.

As used herein, the phrase at least one of A, B, and C should be construed to mean a logical (A OR B OR C), using a non-exclusive logical OR, and should not be construed to mean “at least one of A, at least one of B, and at least one of C.” In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “control circuit” and other elements (components) shown in FIGS. 3 and 4A-4B (generally called circuits) may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term code, as used above, may include software, firmware, and/or microcode, and may refer to programs, routines, functions, classes, data structures, and/or objects. The term shared processor circuit encompasses a single processor circuit that executes some or all code from multiple circuits. The term group processor circuit encompasses a processor circuit that, in combination with additional processor circuits, executes some or all code from one or more circuits. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple circuits. The term group memory circuit encompasses a memory circuit that, in combination with additional memories, stores some or all code from one or more circuits.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

What is claimed is:

1. A communication device configured to communicate with a link partner via a link, the communication device comprising:
a sampling circuit configured to sample a signal received via the link and to output samples;
a clock generator configured to generate a clock;
a control circuit configured to adjust a frequency of the clock; and
a matched filter configured to receive the clock and the samples, compare the samples to a sequence of bits, and output peaks in response to the samples matching the sequence of bits and in response to the frequency of the clock being offset from a frequency of the signal by less than or equal to a predetermined amount.

2. The communication device of claim 1 wherein the clock generator is configured to generate the clock without using a reference clock.

3. The communication device of claim 1 wherein the clock generator is configured to generate the clock without using a crystal oscillator.

4. The communication device of claim 1 wherein the matched filter is configured to output the peaks in presence of noise in the signal.

5. The communication device of claim 1 wherein the peaks have values greater than or equal to a predetermined threshold.

6. The communication device of claim 1 wherein the control circuit is configured to:
select an initial frequency for adjusting the clock;
change the selected frequency until the matched filter outputs a peak; and
fine-tune a last selected frequency at which the matched filter outputs the peak to set the frequency of the clock.

7. The communication device of claim 1 wherein the signal comprises bursts of pulses with each burst being of a fixed duration and with successive bursts being separated by a fixed spacing.

8. The communication device of claim 7 further comprising a signal detector configured to detect the bursts, wherein the control circuit is configured to adjust the frequency of the clock based on duration of the detected bursts and spacing between the detected bursts.

9. The communication device of claim 7 wherein each burst comprises a pseudo-random bit sequence (PRBS) that keeps advancing by one bit position every bit time between the successive bursts.

10. The communication device of claim 7 wherein the control circuit is configured to:
count number of cycles of the clock between two successive bursts of pulses; and
adjust the frequency of the clock based on the count.

11. The communication device of claim 7 wherein the control circuit is configured to:
count number of cycles of the clock between pairs of successive bursts of pulses; and
adjust the frequency of the clock based on an average of the counts.

12. The communication device of claim 7 wherein the control circuit is configured to:
count number of cycles of the clock between first peaks output by the matched filter for two successive bursts of pulses; and
adjust the frequency of the clock based on the count.

13. The communication device of claim 7 wherein the control circuit is configured to:
count number of cycles of the clock between first peaks output by the matched filter for first and third bursts of pulses; and
adjust the frequency of the clock based on the count.

14. The communication device of claim 7 wherein the control circuit is configured to:
count number of cycles of the clock for a duration of (i) a first burst of pulses, (ii) between two successive bursts of pulses, and (iii) a second burst of pulses;
adjust the frequency of the clock based on the count between two successive bursts of pulses in response to the three counts being within an expected variation of the clock generator;
count, in response to the match filer detecting peaks in response to the adjustment, number of cycles of the clock between first peaks output by the matched filter for two successive bursts of pulses; and
set the frequency of the clock based on the count of cycles of the clock between the first peaks.

15. The communication device of claim 7 wherein the control circuit is configured to:
count number of cycles of the clock for a duration of (i) a first burst of pulses, (ii) between two successive bursts of pulses, and (iii) a second burst of pulses;
adjust the frequency of the clock based on the count between two successive bursts of pulses in response to the three counts being within an expected variation of the clock generator;
change the adjusted frequency non-linearly until the matched filter outputs a peak in response to the match filer detecting peaks in response to the adjustment;
count, in response to the match filer detecting peaks, number of cycles of the clock between first peaks output by the matched filter for two successive bursts of pulses; and
set the frequency of the clock based on the count of cycles of the clock between the first peaks.

16. The communication device of claim 1 further comprising a transmitter configured to transmit, using the clock with the adjusted frequency, a second signal to the link partner via the link in response to the received signal.
